(19) United States
(12) Patent Application Publication
(10) Pub. No.: US 2016/0210011 A1
(43) Pub. Date: Jul. 21, 2016

(54) MOBILE DEVICE AND METHOD FOR OPERATING APPLICATION THEREOF

(71) Applicant: Wistron Corporation, New Taipei City (TW)

(72) Inventor: Kuan-Ying Ho, New Taipei City (TW)

(21) Appl. No.: 14/710,594

(22) Filed: May 13, 2015

(30) Foreign Application Priority Data
Jan. 20, 2015 (TW) 104101776

(51) Int. Cl. G06F 3/0488; G06F 3/0484; G06F 3/0486; G06F 3/041; G06F 3/0481

(52) U.S. Cl. CPC G06F 3/0488; G06F 3/0412; G06F 3/04817; G06F 3/0486; G06F 3/04812; G06F 3/04842

(57) ABSTRACT

A mobile device and a method for operating application thereof are provided. The method is adapted to the mobile device having a touch panel. The mobile device is connected to an external display. The method includes the following steps. An executive instruction for an application is detected through the touch panel. An external display context corresponding to the external display is obtained according to the executive instruction. The application is set to use the external display as an input/output interface by the external display context.

### CROSS-REFERENCE TO RELATED APPLICATION

This application claims the priority benefit of Taiwan application serial no. 104101776, filed on Jan. 20, 2015. The entirety of the above-mentioned patent application is hereby incorporated by reference herein and made a part of this specification.

### BACKGROUND OF THE INVENTION

1. Field of the Invention

The invention relates to a method for operating application, and more particularly, relates to a mobile device applying an external display and a method for operating application thereof.

2. Description of Related Art

In modern society, electronic devices such as personal computers, notebook computers, smart phones, tablet computers, personal digital assistants (PDA) have become essential in daily life. In response to demands of daily life, it is possible that users need to open and display multiple windows on different screens. At the time, users may connect an external display to an electronic device, so as to utilize a screen extend mode provided by the electronic device to move a part of the opened windows to be displayed on the external display. Further, users may proceed to operations such as selecting for a focused window, switching between window objects and maximizing/minimizing the windows through a mouse or a shortcut key on a keyboard, so as to realize a simultaneous display and operation for the multiple windows.

In general, the screen extend mode may support display data of the external display by utilizing a memory of a display controller (e.g., a display card). That is to say, an effect of screen extension is mainly realized through hardware in conventional technology. However, hardware resources included in mobile devices are quite limited. Moreover, an operating system (e.g., Android, iOS, etc.) used by a mobile device nowadays merely allows single application to operate in the foreground while the rest of applications can only be executed in the background but cannot be operated by users. Even if the mobile device is connected to the external display through technologies such as High Definition Multimedia Interface (HDMI) or WiFi display, only the same content can be displayed or only the same application can be executed on a touch panel of the mobile device and the external display. Therefore, it is an important issue to be solved as how to improve a method for operating application by the mobile device so that the mobile device may provide a more convenient operability.

### SUMMARY OF THE INVENTION

Accordingly, a mobile device and a method for operating application thereof are provided according to the embodiments of the invention, which are capable of executing multiple applications in the foreground at same time for users to operate.

The invention provides a method for operating application, which is adapted to a mobile device having a touch panel, where the mobile device is connected to an external display. Said method include: detecting an executive instruction for an application through a touch panel, obtaining an external display context corresponding to the external display according to the executive instruction, and setting the application to use the external display as an input/output interface by the external display context.

The invention provides a mobile device. The mobile device includes a touch panel, a storage unit and a processing unit. The storage unit records a plurality of modules. The processing unit is coupled to the touch unit and the storage unit to access and execute modules recorded in the storage unit. The modules include an executive instruction detection module and an activity management module. The executive instruction detection module detects an executive instruction for an application through the touch panel. The activity management module obtains an external display context corresponding to the external display according to the executive instruction so as to set the application to use the external display as an input/output interface by the external display context.

Based on the above, according to the mobile device and the method for operating application thereof as proposed by the embodiments of the invention, the application is set by utilizing the external display context (also known as a display configuration) corresponding to the external display so that the application is capable of using the external display as the input/output interface. As a result, the mobile device may execute multiple applications in the foreground and allow users to operate each of the applications, so as to improve the operating experience.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a mobile device according to an embodiment of the invention.

FIG. 2 is a flowchart illustrating a method for operating application according to an embodiment of the invention.

FIG. 3 to FIG. 5 illustrate examples according to an embodiment of the invention.

FIG. 6 illustrates an example according to an embodiment of the invention.

FIG. 7 illustrates an example according to an embodiment of the invention.

FIG. 8 is a block diagram illustrating a mobile device according to an embodiment of the invention.

FIG. 9 is a flowchart illustrating a method for operating application according to an embodiment of the invention.

FIG. 10 illustrates an example according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

A mobile device generally adopts an operating system in single window design, thus users are unable to operate applications executed in the background. In order to allow users to operate multiple applications in the foreground at the same time, based on the “Context” in the Android operating system that is used as an interface for an application, the embodiments of the invention adopt an external display context (also known as an external display interface or a display configuration) corresponding to an external display to set a logical display area of the application to be the external display, so that the external display may serve as an input/output interface of the application. Accordingly, multiple applications may be executed in the foreground at the same time through software design, so as to improve both convenience and operating experience of the mobile device. In order to make the invention more comprehensible, several embodiments are described below as the examples to prove that the invention can actually be realized.

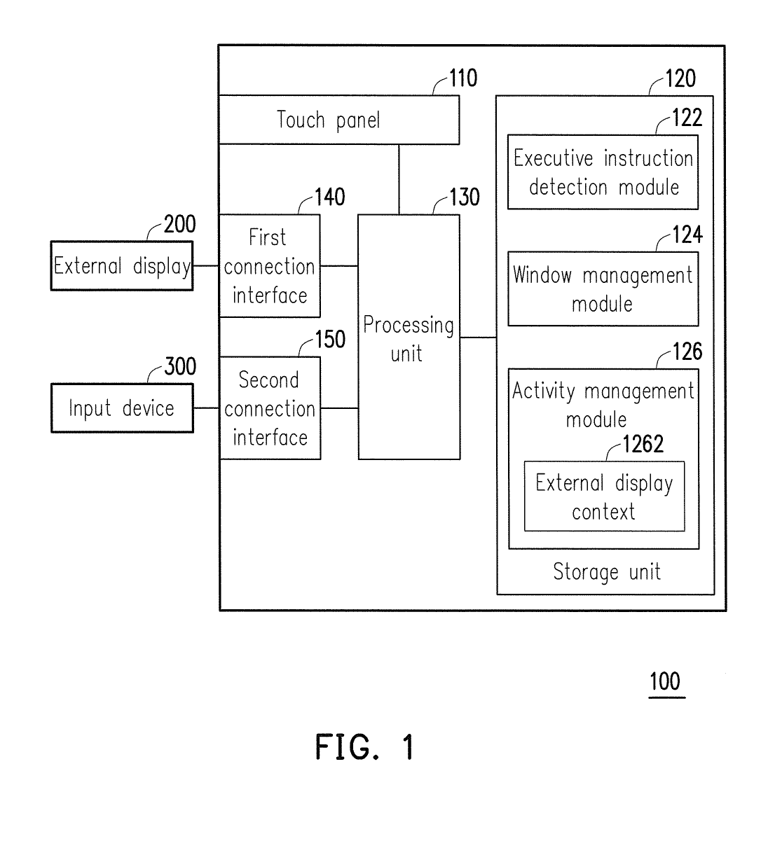

FIG. 1 is a block diagram illustrating a mobile device according to an embodiment of the invention. Referring to FIG. 1, a mobile device 100 may be, for example, one of various portable electronic devices such as a cell phone, a smart phone, a tablet computer, a personal digital assistant, an e-book or a game console. The mobile device 100 includes a touch panel 110, a storage unit 120 and a processing unit 130, and their functions are respectively described as follows.

The touch panel 110 is composed of, for example, a display (including a liquid crystal display (LCD), a light-emitting diode (LED) display, a field emission display (FED) or other displays) together with a touch panel (including a resistive type, a capacitive type, an optical type or an acoustic-wave type), and capable of providing display and touch operation functionalities at the same time.

The storage unit 120 is, for example, a fixed or a movable device in any possible forms including a random access memory (RAM), a read-only memory (ROM), a flash memory or other similar devices, or a combination of the above-mentioned devices. In the present embodiment, the storage unit 120 is configured to record software programs including an executive instruction detection module 122, a window management module 124 (e.g., “PhoneWindowManager”), and an activity management module 126 (e.g., “ActivityManager”). In the present embodiment, the storage unit 120 is not limited to be only one single memory device. Said modules in software manner may also be stored separately in different two or more of the same or different memory devices.

Take a software layer of the Android operating system for example, the executive instruction detection module 122 belongs to, for example, an application layer, and the window management module 124 and the activity management module 126 belong to, for example, a framework layer. Herein, the application layer is configured to, for example, provide applications including “E-mail”, “SMS”, “Calendar”, “Map”, “Browser” and “Contacts”. The framework layer provides, for example, core applications including “Views”, “Content Providers”, “Resource Manager”, “Notification Manager”, “Activity Manager” and so on. In an embodiment, the application layer and the framework layer may be realized by the JAVA language.

The processing unit 130 is coupled to the touch panel 110 and the storage unit 120. The processing unit 130 is, for example, a device with computing capability such as a central processing unit (CPU) or a microprocessor. The processing unit 130 is not limited to be only one single processing device, and it is also possible that two or more processing devices may be used for execution together. In the present embodiment, the processing unit 130 is configured to access and execute the modules recorded in the storage unit 120, so as realize a method for operating application according to the embodiments of the invention.

In addition, the mobile device 100 further includes a first connection interface 140 and a second connection interface 150, which are respectively coupled to the processing unit 130. Herein, the first connection interface 140 is connected to an external display 200, and the first connection interface 140 is, for example, a physical line connection interface (e.g., HDMI), or a wireless transmission interface (e.g., Bluetooth, WiFi, etc.), or a combination of the above and/or other suitable transmission interfaces. The external display 200 is similar to the touch panel 110, and may adopt use of any one of aforementioned displays. It should be note that, whether the external display 200 includes a touch control function is not particularly limited in the invention.

The second connection interface 150 is, for example, a Universal Serial Bus (USB), or the physical line interface or the wireless transmission interface as similar to the first connection interface. The second connection interface 150 is configured to connect an input device 300. The input device 300 is, for example, a peripheral device (e.g., an optical mouse, a wireless mouse, etc.) which is provided for a user to switch focus in order to select the application to be executed in the foreground and to operate the application through the input device 300.

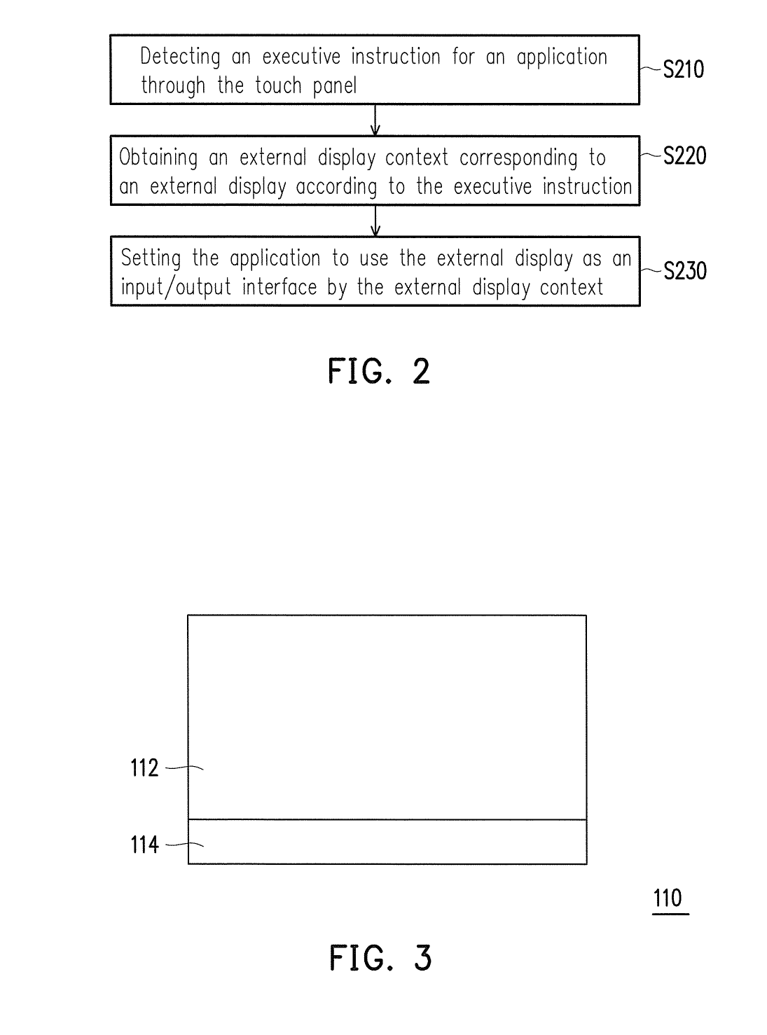

FIG. 2 is a flowchart illustrating a method for operating application according to an embodiment of the invention, and the method is adapted to the mobile device 100 of FIG. 1. Detailed steps of the method are described below with reference to each element in FIG. 1.

Referring to FIG. 1 and FIG. 2 together, in step S210, the executive instruction detection module 122 detects an executive instruction for an application through the touch panel 110. In step S220, the activity management module 126 obtains an external display context 1262 corresponding to the external display 200 according to the executive instruction. Further, in step S230, the activity management module 126 sets the application to use the external display 200 as an input/output interface by the external display context 1262.

Specifically, in an embodiment, the executive instruction detection modules 122 may display an icon corresponding to the application through the touch panel 110, and receive a touch operation for the icon in order to trigger the executive instruction. Therefore, when the user wishes to have the application executed on the external display 200 (i.e., set the external display 200 as the input/output interface) and accordingly performs the touch operation on the icon of the application, the executive instruction detecting 122 may trigger the corresponding executive instruction. Herein, the executive instruction is capable of allowing the activity management module 126 to obtain the external display context in step S220, and setting the input/output interface in the subsequent steps, which are described in the following embodiments.

The touch operation may be, for example, a selection operation for the icon or a dragging operation for the icon, which are provided as different operating methods for the user to decide whether the application uses the touch panel 110 or the external display 200 as the input/output interface. Details regarding the above are provided with reference to the following embodiments.

First of all, in an embodiment, the executive instruction detection module 122 may receive the selection operation for the icon, so as to determine that the application uses the external display 200 as the input/output interface according to a lookup table to thereby trigger the executive instruction. In other words, in such embodiment, the input/output interface used by each of the applications on the mobile device 100 may be decided based on settings previously recorded in the lookup table. The lookup table is, for example, stored in the storage unit 120, and provided for the processing unit 130 to access.

In an embodiment, the executive instruction detection module 122 provides, for example, a setup menu for the user to set the application as well as the input/output interface used by the application. As such, once the user performs the selection operation (e.g., click, long click, etc.) on the icon for the application in order to start the application, the executive instruction detection module 122 may determine whether the input/output interface of the application is set to be the external display 200. If yes, the executive instruction detection module 122 triggers the executive instruction, so that the activity management module 126 may execute the application on the external display 200 according to above setting in the subsequent steps.

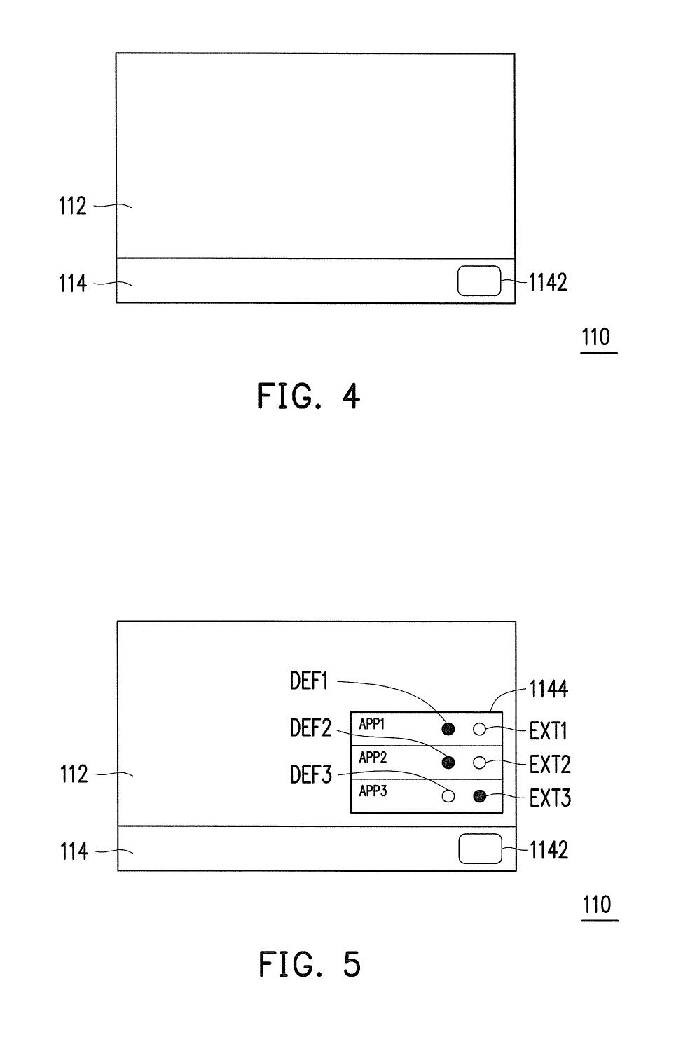

An embodiment is provided below for further description. FIG. 3 to FIG. 5 illustrate examples according to an embodiment of the invention. Referring to FIG. 3, FIG. 3 illustrates a screen displayed on the touch panel 110 before the mobile device 100 is connected to the external display 200. Herein, the screen displayed on the touch panel 110 may include a main screen 112 and a navigation bar 114. Next, referring to FIG. 4, when the mobile device 100 is connected to the external display 200, an icon 1142 corresponding to a display setting list is displayed in the navigation bar 114. In an embodiment, the icon 1142 is displayed in form of, for example, buttons. Further, in the present embodiment, the icon 1142 may be located on the right side of the navigation bar 114, but the invention is not limited thereto. Referring to FIG. 5, when the user performs the touch operation (click or long click) on the icon 1142, a display setting list 1144 may be activated and displayed on the touch panel 110. The display setting list 1144 lists, for example, all of applications APP1, APP2 and APP3 currently executed on the mobile device 100, icons DEF1 to DEF3 for deciding whether to use the touch panel 110 as the input/output interface for each of the applications, and icons EXT1 to EXT3 for using the external display 200 as the input/output interface. The user may perform a clicking operation on the icons DEF1 to DEF3 and EXT1 to EXT3 to make selections. In the embodiment of FIG. 5, on a basis that a solid circular icon denotes “selected (enabled)” and a hollow circular icon denotes “unselected (disabled)”, the applications APP1 and APP2 are, for example, set to use the touch panel 110 as the input/output interface, whereas the application APP3 is, for example, set to use the external display 200 as the input/output interface.

As such, the present embodiment is capable of receiving the setting made by the user for the input/output interface used by each of the application through the display setting list 1144, and archiving the applications using the external display 200 as the input/output interface into the lookup table according to data collected by display setting list 1144. Accordingly, when one application is started by the user (e.g., when the touch operation such as clicking on the icon of the application), the executive instruction detection module 122 may compare and search contents recorded in the lookup table to thereby determine whether such application uses the external display 200 as the input/output interface.

If aforementioned example is to be realized in software, in an embodiment, the executive instruction detection module 122 may register a listener (e.g., “DisplayListener”) to a display manager (e.g., “DisplayManager”) in a navigation bar display class (e.g., “NavigationBarView”), so as to listen to whether an event where the mobile device 100 is connected to the external display 200 occurs. When detecting that the mobile device 100 is connected to the external display 200, the executive instruction detection module 122 may display the icon 1142 corresponding to the display setting list 1144 on the navigation bar 114, so that the touch operation of the user may be received through the icon 1142 to activate the display setting list 1144. Thereafter, the executive instruction detection module 122 may receive the made by user for the input/output interface used by each of the applications through each of the icons (e.g., the icons DEFT to DEF3 and EXT1 to EXT3 as depicted in FIG. 5) in the display setting list 1144.

In the present embodiment, when the application is set to use the external display 200 as the input/output interface, the executive instruction detection module 122 may record a package name of that application into the lookup table. Each time when one application is started, the executive instruction 122 compares such application with the lookup table. If the package name of the application is stored in the lookup table, the executive instruction detection module 122 may trigger the executive instruction, so that the activity management module 126 may use a base display context creating function (e.g., calling for the “ActivityThread.createBaseContextForActivity” function) to generate a display context, and such display context bundles itself to the external display 200 through an external display context creating function (e.g., the “createDisplayContext” function). It should be noted that, while obtaining the external display context of the external display 200, aforesaid functions may also have the application pointing to the external display 200. As a result, the application may use the external display 200 as the input/output interface. Otherwise, if the package name of the application does not exist in the lookup table, the mobile device 100 generates a base display context according to an original path provided in the Android operating system, so that the application may use the touch panel 110 of the mobile device 100 as the input/output interface. In other words, the application will be executed on the touch panel 110.

In the present embodiment, the lookup table records the package name of the application that uses the external display 200 as the input/output interface. In other embodiment, the lookup table may also be used to record all the input/output interfaces respectively used by the applications and persons who applying the present embodiment may adaptively provide comparison information through the lookup table based on design requirements, and the invention is not limited to the above.

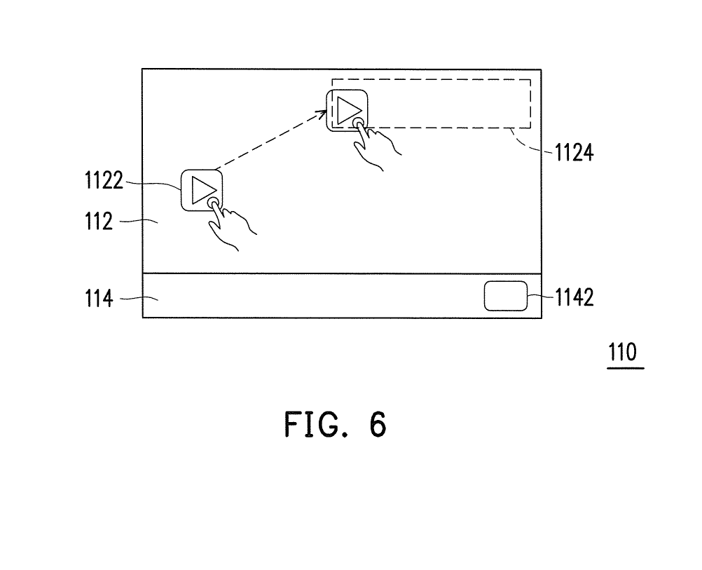

It should be noted that, besides the input/output interface used by the application may be set in advance by utilizing the lookup table, the user may also perform the touch operation on the icon of the application to instantly decide whether to use the touch panel 110 or the external display 200 as the input/output interface for the application in another embodiment. Specifically, in such embodiment, the executive instruction detection module 122 may receive a dragging operation for dragging the icon of the application into a setup area to thereby trigger the executive instruction. In other words, when the user drags the icon of the application to the setup area, it indicates that the user wishes to have the application executed on the external display 200. An embodiment is further provided below with reference to FIG. 6.

FIG. 6 illustrates an example according to an embodiment of the invention. Referring to FIG. 6, an icon 1122 of the application is displayed on the touch panel 110. The user may, for example, perform the touch operation such as long click on the icon 1122 in order to trigger the executive instruction so that the executive instruction detection module 122 displays a setup area 1124 on the touch panel 110. In the present embodiment, the setup area 1124 may be displayed on the upper-right of the touch panel 110. In addition, descriptive icons and texts may also be displayed in the setup area 1124 to provide prompting information regarding the setup area 1124 for the user. When the user drags the icon 1122 so that icon 1122 moves into the setup area 1124 with the dragging operation of the user, the executive instruction detection module 122 may display the icon 1122 in a highlighted fashion, for example. Further, when detecting that the touch operation of the user for the icon 1122 completes within the setup area 1124 (i.e., releasing the icon 1122), the executive instruction detection module 122 may further trigger the executive instruction for setting the external display 200 as the input/output interface used by the application.

If aforementioned example is to be realized in software, in an embodiment, the executive instruction detection module 122 may, for example, register a listener (“Listener Interface”) within a shortcut area (“Hotseat”) in a desktop program (e.g., the “Launcher” in the Android operating system), and add one block in the “View” of the “Drop Target Bar” to serve as the setup area 1124. In addition, the executive instruction detection module 122 may also create a drop target object (e.g., the “ButtonDropTarget” object, and a name of such object may declared as “ExtendDropTarget”) which is used to process an event where the icon 1122 is dragged and dropped into the setup area 1124. When detecting that the touch operation of the user is to drag the icon 1122 of the application into the setup area 1124 and then release the icon, the execution instruction detection module 122 may mark such application in order to generate a triggering instruction. In other words, the marking is used to determine whether the application uses the external display 200 as the input/output interface.

The touch operation for dragging the icon into the setup area 1124 and then releasing the icon is merely an example, persons who applying the present embodiment may also use other touch operations or a combination of a plurality of touch operations to serve as a basis for the execution instruction detection module 122 to mark the application. Types of the touch operation are not particularly limited in the embodiments of the invention.

On the other hand, in the example shown in FIG. 6, if the user simply clicks on the icon 1122, the executive instruction for setting the application to use the external display 200 as the input/output interface will not trigger. In this case, the mobile device 100 sets the application to use the touch panel 110 as the input/output interface according to a general setting, and performs a click event dispatch by using a clicking event function (e.g., “onTouchevent”) through a drag control (e.g., “DragController”) after receiving the clicking operation from the user, so as to execute the application on the touch panel 110.

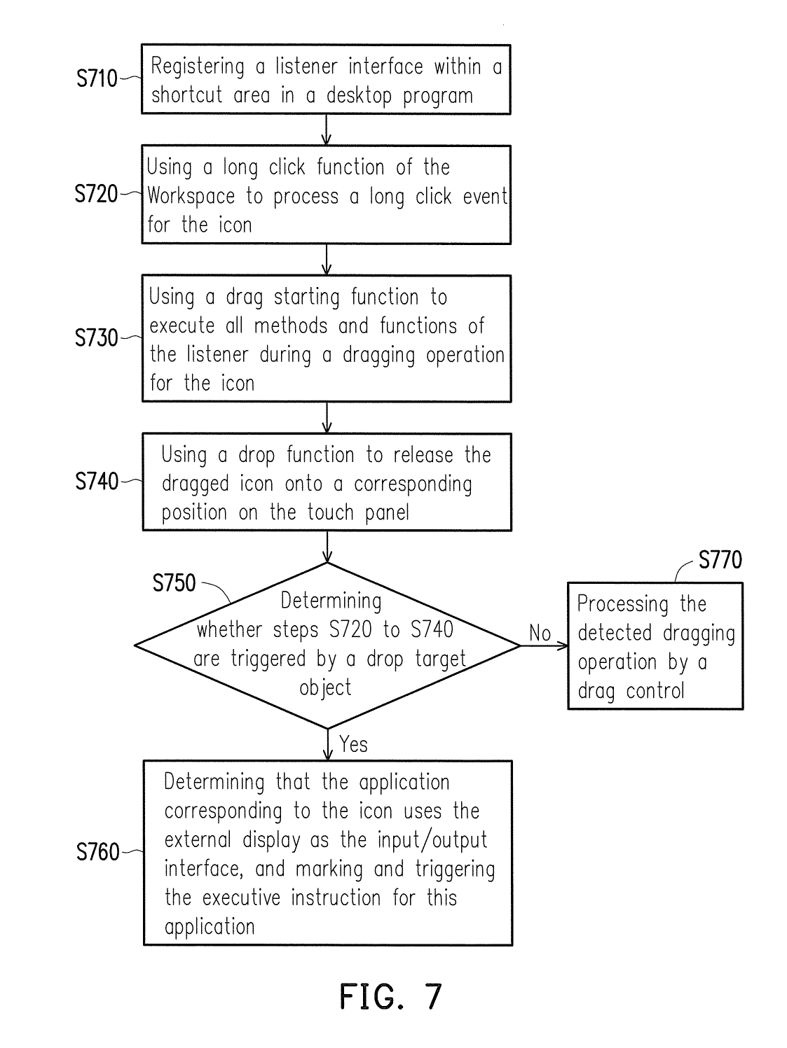

FIG. 7 further describes specific processes of the foregoing embodiments in which the executive instruction detection module 122 detects the dragging operation of the user and thereby determines that the application uses the external display 200 as the input/output interface.

Referring to FIG. 7, FIG. 7 illustrates an example according to an embodiment of the invention. In step S710, a listener interface within a shortcut area is registered in a desktop program. In step S720, a long click function (e.g., the “onLongClick(View)” function) of the “Workspace” is used to process a long click event for the icon 1122. Subsequently, in step S730, a drag starting function (e.g., the “StartDrag( )” function) is used to execute all methods and functions of the listener during a dragging operation for the icon 1122. Thereafter, when listening that the dragging operation is completed, proceeding to step S740, where a drop function (e.g., the “Drop( )” function) is used to release the dragged icon 1122 onto a corresponding position on the touch panel 110. Subsequently, in step S750, the executive instruction detection module 122 determines whether steps S720 to S740 are triggered by the drop target object. If yes, in step S760, the executive instruction detection module 122 may determine that the application corresponding to the icon 1122 uses the external display 200 as the input/output interface, and mark and trigger the executive instruction for this application. If no, in step S770, the detected dragging operation is processed by the drag control.

The foregoing embodiment illustrates how to determine whether the application is executed on the external display according to the touch operation of the user. In the following embodiment, a method regarding how the activity management module 126 sets the input/output interface of the application to be the external display 200 by the external display context 1262 according to the executive instruction is further described.

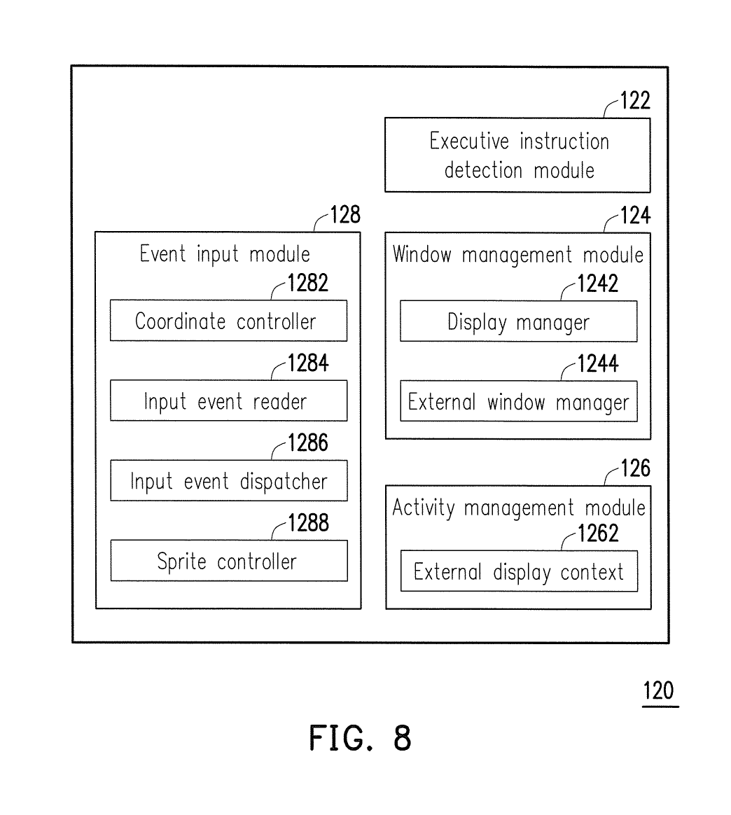

Referring to FIG. 8, FIG. 8 is a block diagram illustrating a mobile device according to an embodiment of the invention, in which the modules recorded in the storage unit 120 are described in detail. Herein, the window management module 124 may include a display manager 1242 and an external window manager 1244. The display manager 1242 may be used to realize a display manger service. The external window manager 1244 may be used to initialize a window setup of the external display 200.

It should be noted that, in the Android operating system, the base display context (“BaseContext”) is generally used as the context for each of applications. Herein, the base display context may be used to access resources included in the application, control a life cycle of the application and decide the logical display area of the application (i.e., deciding the input/output interface used by the application). Nonetheless, the base display context merely makes the application pointing to the touch panel 110 of the mobile device 100, thus only the touch panel 110 can be set as the input/output interface of the application. Therefore, in the present embodiment, after the executive instruction detection module 122 detects the executive instruction by which the user intends to set the input/output interface of the application to be the external display 200, the activity management module 126 may further obtain the external display context 1262 according to the executive instruction and provide external display context 1262 to the application, so as to designate the application to use the external display 200 as the input/output interface. Accordingly, the present embodiment is capable of realizing the function of using the external display 200 as the input/output interface of the application by utilizing the external display context 1262 to replace the base display context.

In particular, for making the external display 200 to become a display device that can be independently used rather than simply outputting a signal content identical to that of the touch panel 100, in an embodiment, a coordinate system for the external display 200 may also be set by the display manager 1242 according to a screen resolution of the external display 200, so that input data to be provided to the external display 200 may be decided according to the coordinate system. Accordingly, the mobile device 100 may consider the external display 200 as a physical display, and based on the screen resolution or other hardware resources of the external display 200, the display manager 1242 may enable the external display 200 to output a content different from that of the touch panel 110 according to the coordinate system of the external display 200. Moreover, considering that the external display 200 is generally preset to display the same screen (i.e., mirror display) of the touch panel 110 when the mobile device 100 is connected to the external display 200, in the present embodiment, the display manager 1242 may also provide an equivalent function of converting the external display 200 from a logical display into the physical display.

Further, the function of independently executing the application on the external display 200 may also be realized by utilizing the external display context 1262 to designate the application to use the external display 200 as the input/output interface. Specifically, in an embodiment, the external window manager 1244 may be obtained by the window management module 124 according to the executive instruction, and the setup of the external display may be initialized by the external window manager 1244 before the application is started. On the other hand, after the application is started, the activity management module 126 further obtains the external display context 1262 corresponding to the external display 200. In an embodiment, the activity management module 126 may use the base display context creating function (e.g., the activity management module 126 may call for the “createDisplayContext(appContext, display)” function in the “ActivityThread”), so as to obtain the external display context 1262 corresponding to the external display 200 and designate the application to use the external display context 1262 as its context. As a result, the application may use the external display 200 as the input/output interface according to the setup of the external display context 1262.

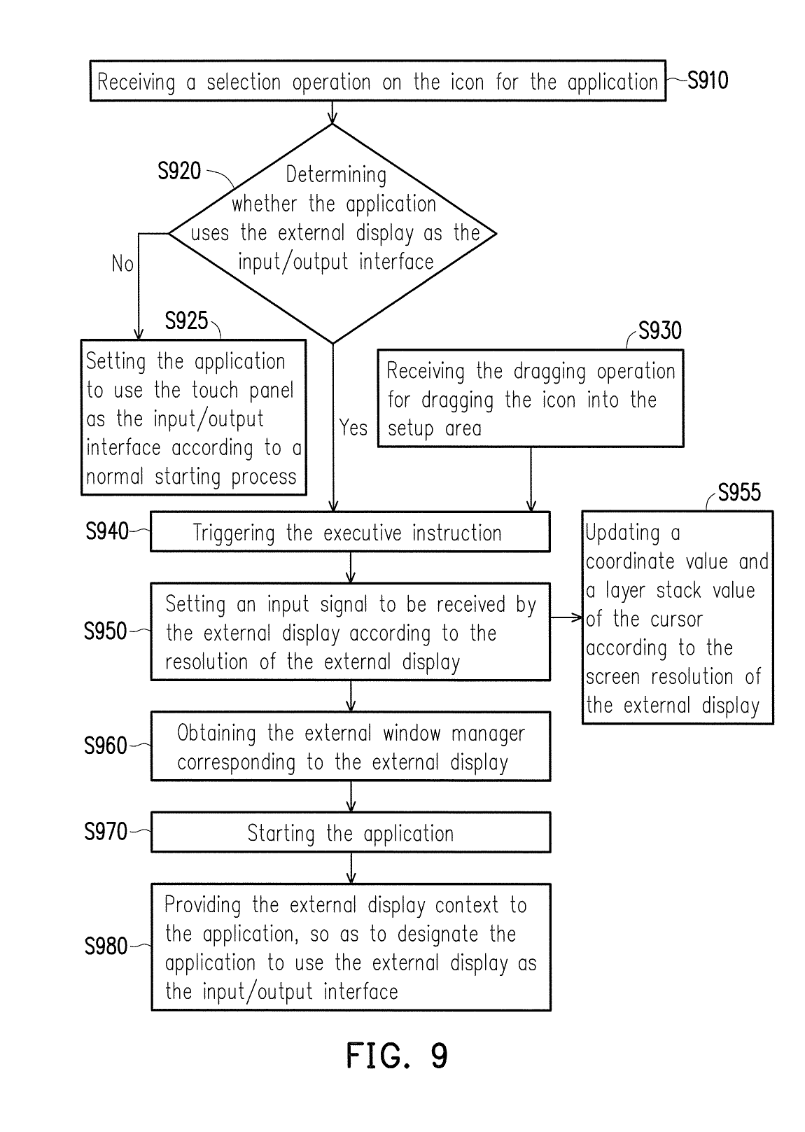

FIG. 9 is a flowchart illustrating a method for operating application according to an embodiment of the invention, in which specific steps for realizing the foregoing embodiment in software are illustrated. Herein, steps S910 to S920 are corresponding to a situation where the input/output interface of the application is preset, and step S930 is corresponding to a situation where the application is decided to the external display as the input/output interface according to the icon of the application being dragged into the setup area. Specifically, the executive instruction detection module 122 receives a selection operation on the icon for the application in step S910, and the executive instruction detection module 122 determines whether the application uses the external display 200 as the input/output interface in step S920. When the executive instruction detection module 122 determines that the application uses the external display 200 as the input/output interface, proceeding to step S940, in which the executive instruction is triggered. In the case when determining that the application does not use the external display 200 as the input/output interface, proceeding to step S925, in which the application is set to use the touch panel 110 as the input/output interface according to a normal starting process. On the other hand, in step S930, the executive instruction detection module 122 receives the dragging operation for dragging the icon into the setup area, so that the executive instruction may be triggered accordingly in step S940.

Thereafter, in step S950, the display manager 1242 sets an input signal to be received by the external display 200 according to the resolution of the external display 200. In step S960, the window management module 124 obtains the external window manager 1244 corresponding to the external display 200. Herein, the window management module 124 may use a window management function (e.g., the “WindowManagerImpl(Display)” function in “addStartingWindow( )”) in order to obtain the external window manager 1244, and initialize a window display setup of the external display 200 through the external window manager 1244. Subsequently, in step S970, the application is started. Thereafter, in step S980, the activity management module 126 obtains the external display context 1262, and provides the external display context 1262 to the application, so as to designate the application to use the external display 200 as the input/output interface.

It should be noted that, the mobile device 100 proposed in the embodiments of the invention may even allow the user to switch focus between the touch panel 110 and the external display 200 through a cursor of the input device 300. Accordingly, regardless of whether the application uses the touch panel 110 or the external display 200 as the input/output interface, the user is able to operate the application executed on either the touch panel 110 or the external display 200.

Specifically, in an embodiment, the mobile device 100 may display the cursor of the input device 300 on the external display 200 by an event input module 128. As shown in FIG. 8, the event input module 128 may be recorded in the storage unit 120. Herein, the event input module 128 may include a coordinate controller 1282 (e.g., “PointController”), an input event reader 1284 (e.g., “InputReader”), an input event dispatcher 1286 (e.g., “InputDispatcher”) and a sprite controller 1288 (e.g., “SpriteController”). In an embodiment, if the mobile device 100 is operated by the Android operating system, the event input module 128 belongs to, for example, the framework layer. Functions of the event input module 128 are specifically described as follows.

As described above, because the display manager 1242 decides the input signal of the external display 200 according to the screen resolution of the external display 200, the external display 200 of the present embodiment may include a coordinate system different from that of the touch panel 110. Therefore, if the cursor of the input device 300 is to be displayed on the external display 200, the coordinate controller 1282 may update a coordinate value and a layer stack value (e.g., “LayerStack”) of the cursor according to the screen resolution of the external display 200, so as to renew a position where the cursor is displayed on the external display 200 (as shown in step S955). In addition, the coordinate controller 1282 may also be used to update signals for the display.

The input event reader 1284, the input event dispatcher 1286 and the sprite controller 1288 are used to process an input event. The input event reader 1284 may be used to read original event data (“RawEvent”), and convert the read original event data into a specific event by, for example, an input mapper (“InputMapper”). The input event dispatcher 1286 may be used to receive the specific event and dispatch the specific event to the application.

For instance, with respect to a display event for displaying the cursor of the input device 300 on the external display 200, the input event reader 1284 may use a cursor input mapping function (e.g., the “CursorInputMapper” function) to update a rendered surface of the cursor according to the screen resolution of the external display 200, and the sprite controller 1288 may use a cursor updating function (e.g., the “doUpdateSprite” function) to update a layer stack property of the rendered surface. As for the input event of the input device 300, the input event dispatcher 1286 may use a motion dispatching function (e.g., the “dispatchMotion” function) to search a window target to dispatch motion. Accordingly, in the present embodiment, other than setting the input/output interface of the application to be the external display 200, through use of the event input module 128, the user may also operate the application that uses the external display 200 as the input/output interface by the input device 300.

Especially, it is worth mentioning that, in the case where the cursor of the input device 300 moves from one display to another display, because the touch panel 110 and the external display 200 use different coordinate systems for displaying, it is required to switch between coordinate systems for the cursor as the cursor moves from the touch panel 110 to the external display 200 (or the cursor moves from the external display 200 to the touch panel 110), so as to obtain a corresponding coordinate position of the cursor on the touch panel 110 or the external display 200. With respect to a process for switching a coordinate of the cursor, in an embodiment, a motion status of the input device 300 may be detected by the event input module 128, and the cursor of the input device 300 may be displayed on the touch panel 110 or the external display 200 by the display manager 1242 according to a detection result of the event input module 128. In other words, in the present embodiment, the process for switching the coordinate of the cursor may be executed by the display manager 1242. Furthermore, in other embodiments, said process for switching the coordinate of the cursor may also be realized by the event input module 128 alone.

Take the cursor moving from the touch panel 110 to the external display 200 as an example, in an embodiment, the display manager 1242 first displays the cursor corresponding to the input device 300 on the touch panel 110, where the cursor correspondingly moves on the touch panel 110 according to a motion of the input device 300. Subsequently, the display manager 1242 determines that the cursor moves to a first edge of the touch panel 110. Then, based on a ratio between a first resolution of the first edge of the touch panel 110 and a second resolution of a second edge on the same side of the external display 220 and the touch panel 110, the display manager 1242 decides a display position of the cursor on the second edge of the external display 200, so as to continue displaying the cursor on the external display 200 from the display position. Herein, the first and second edges may correspond to an arranging manner of the external display 200 and the touch panel 110 (e.g., with a relative arrangement in a side-by-side manner or an up-and-down manner). However, relative locations of the touch panel 110 and the external display 200 are not particularly limited in the invention.

For example, in an embodiment, the touch panel 110 and the external display 200 are arranged at the relative locations in the side-by-side manner. When the cursor of the input device 300 moves from left to right on the touch panel 110 to a place that is ⅔ of the edge length from the bottom of the edge on the same side of the external display 200 (when the cursor moves from left to right on the touch panel 110 to a right edge (the first edge) of the touch panel 110), the display manager 1242 may continue to display the cursor on the external display 200 from the place that is ⅔ of the edge length from the bottom of a left edge (the second edge) of the external display 200.

Especially, it is worth mentioning that, with respect to an ordinary electronic device that operates in the screen extend mode, in the case where screen resolutions of a main screen and an extension screen are different, when the user intends to move the cursor of the input device 300 from the screen with higher resolution to the screen with lower resolution, it may occur that the cursor cannot move to the screen with lower resolution. On the other hand, the mobile device 100 of the present embodiment is capable of deciding how to switch and move the cursor between the touch panel 110 and the external display 200 by the ratio of the first resolution and the second resolution of the first and second edges, so as to effectively solve above issue in which the cursor cannot move successfully.

In addition, after the display manager 1242 determines that the cursor moves to the first edge of the touch panel 110, in an embodiment, the external display 200 may also be set to be the extension screen extended from the first edge of the touch panel 110 by the external display context 1262. Accordingly, each time when determining that the cursor moves to one of the edges of the touch panel 110, the display manager 1242 may move the cursor from the edge on the same side of the external display 200 and the touch panel 110 into the external display 200 for displaying, such that it can be more convenient to switch and move the cursor between the external display 200 and the touch panel 110.

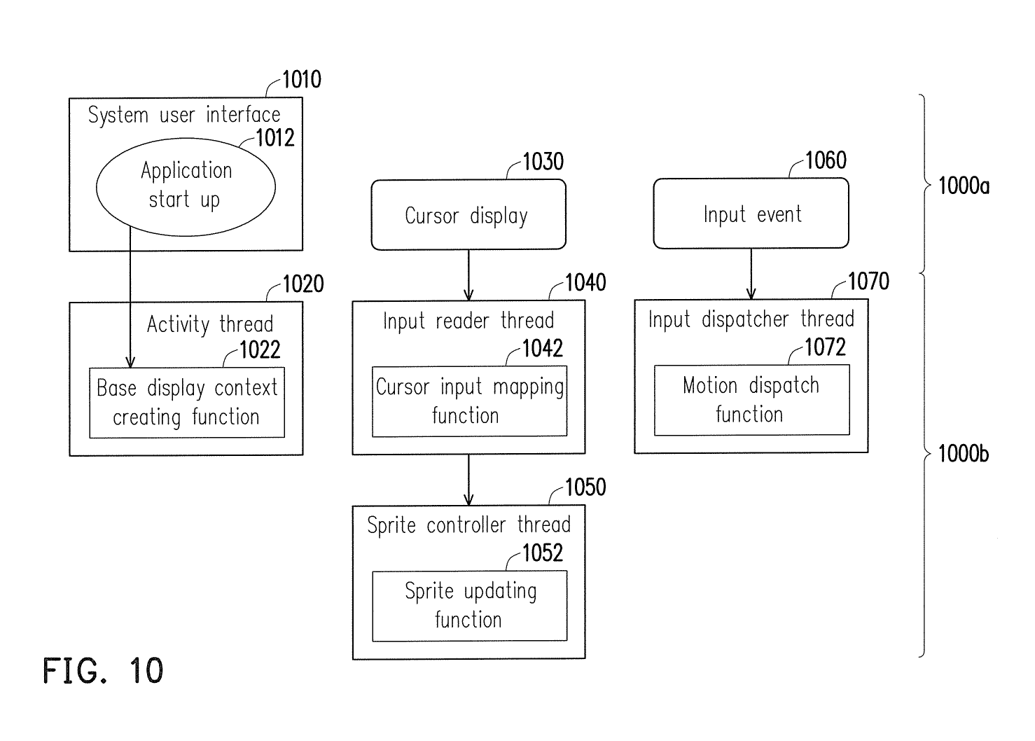

The foregoing embodiment is described below in a viewpoint of the software layer in the Android operating system. FIG. 10 illustrates an example according to an embodiment of the invention. Referring to FIG. 10, a system user interface 1010 (e.g., “SystemUI (System User Interface)”) detects an application start up event 1012 in an application layer 1000a in order to start a corresponding activity. Subsequently, the activity management module 126 may use a base display context creating function 1022 (e.g., the “createBaseContextForActivity” function) in an activity thread 1020 to determine whether the application is set to use the external display 200 as the input/output interface. When a determination result of the above is yes, the activity management module 126 may obtain the external display context 1262 corresponding to the external display 200.

On the other hand, with respect to a cursor display event 1030, the input event reader 1284 may use a cursor input mapping function 1042 (e.g., the “CursorInputMapper” function) in an input reader thread 1040 to update the coordinate, and the sprite controller 1288 may use a sprite updating function 1052 (e.g., the “doUpdateSprite” function) in a sprite controller thread 1050 to update the rendered surface and the layer stack property of the cursor.

As for an input event 1060 of the input device 300, the input event dispatcher 1286 may use a motion dispatch function 1072 (e.g., the “displatchMotion” function) in an input dispatcher thread 1070 to search a window target to dispatch motion. The activity management module 126, the input event reader 1284, the sprite controller 1288 and the input event dispatcher 1286 may all belong to a framework layer 1000b in the Android operating system.

In summary, according to the mobile device and the method for operating application thereof proposed by the embodiments of the invention, the application is set by utilizing the external display context corresponding to the external display so that the application may use the external display as the input/output interface. It addition, the embodiments of the invention may also allow the user to switch focus between the touch panel and the external display through the cursor of the input device. As such, regardless of whether the application uses the touch panel or the external display as the input/output interface, the user is able operate the application operated on the touch panel or the external display. Accordingly, the embodiments of the invention are capable of allowing multiple applications to be executed in the foreground at the same time through software design, so as improve both convenience and operating experience of the mobile device.

Although the present disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for operating application, adapted to a mobile device having a touch panel, wherein the mobile device is connected to an external display, and the method comprises:
detecting an executive instruction for an application through the touch panel;
obtaining an external display context corresponding to the external display according to the executive instruction; and
setting the application to use the external display as an input/output interface by the external display context.

2. The method for operating application of claim 1, wherein the step of setting the application to use the external display as the input/output interface by the external display context comprises:
setting a coordinate system for the external display according to a screen resolution of the external display; and
deciding input data to be provided to the external display according to the coordinate system.

3. The method for operating application of claim 2, wherein the mobile device is further connected to an input device, and the method further comprises:
displaying a cursor corresponding to the input device on the touch panel, wherein the cursor correspondingly moves on the touch panel according to a motion of the input device;
determining that the cursor moves to a first edge of the touch panel;
based on a ratio between a first resolution of the first edge and a second resolution of a second edge on the same side of the external display and the touch panel, deciding a display position of the cursor on the second edge of the external display; and
continuing to display the cursor on the external display from the display position.

4. The method for operating application of claim 2, wherein after the step of determining that the cursor moves to the first edge of the touch panel, the method further comprises:
setting the external display as an extension screen extended from the first edge of the touch panel by the external display context.

5. The method for operating application of claim 2, further comprising:
obtaining an external window manager corresponding to the external display according to the executive instruction; and
initializing a setup of the external display by the external window manager.

6. The method for operating application of claim 1, wherein the step of setting the application to use the external display as the input/output interface by the external display context comprises:
providing the external display context to the application to designate the application to use the external display as the input/output interface.

7. The method for operating application of claim 1, wherein the step of detecting the executive instruction for the application through the touch panel comprises:
displaying an icon corresponding to the application through the touch panel; and
receiving a touch operation for the icon in order to trigger the executive instruction.

8. The method for operating application of claim 7, wherein the step of receiving the touch operation for the icon in order to trigger the executive instruction comprises:
receiving a dragging operation for dragging the icon into a setup area in order to trigger the executive instruction.

9. The method for operating application of claim 7, wherein the step of receiving the touch operation for the icon in order to trigger the executive instruction comprises:
receiving a selection operation for the icon, so as to determine that the application uses the external display as the input/output interface according to a lookup table in order to trigger the executive instruction.

10. A mobile device, comprising:
a first connection interface, connecting an external display;
a touch panel;
a storage unit, recording a plurality of modules; and
a processing unit, coupled to the first connection interface, the touch panel and the storage unit, and configured to access and execute the modules recorded in the storage unit, and the modules comprising:
an executive instruction detection module, detecting an executive instruction for an application through the touch panel; and
an activity management module, generating an external display context corresponding to the external display according to the executive instruction, so as to set the application to use the external display as an input/output interface by the external display context.

11. The mobile device of claim 10, wherein the mobile device further comprises:
a window management module, which comprises:
a display manager, setting a coordinate system for the external display according to a screen resolution of the external display, and deciding input data to be provided to the external display according to the coordinate system.

12. The mobile device of claim 11, wherein the mobile device further comprises:
a second connection interface, connecting an input device;
wherein the display manager displays a cursor corresponding to the input device on the touch panel, wherein the cursor correspondingly moves on the touch panel according to a motion of the input device, the display manager determines that the cursor moves to a first edge of the touch panel, based on a ratio between a first resolution of the first edge and a second resolution of a second edge on the same side of the external display and the touch panel, decides a display position of the cursor on the second edge of the external display, and continues to display the cursor on the external display from the display position.

13. The mobile device of claim 11, wherein the display manager further sets the external display as an extension screen extended from the first edge of the touch panel by the external display context.

14. The mobile device of claim 11, wherein the display manager obtains an external window manager corresponding to the external display according to the executive instruction, and initializes a setup of the external display by the external window manager.

15. The mobile device of claim 10, wherein the activity management module provides the external display context to the application to designate the application to use the external display as the input/output interface.

16. The mobile device of claim 10, wherein the executive instruction detection module displays an icon corresponding to the application through the touch panel, and receives a touch operation for the icon in order to trigger the executive instruction.

17. The mobile device of claim 16, wherein the executive instruction detection module receives a dragging operation for dragging the icon into a setup area in order to trigger the executive instruction.

18. The mobile device of claim 16, wherein the executive instruction detection module receives a selection operation for the icon, so as to determine that the application uses the external display as the input/output interface according to a lookup table in order to trigger the executive instruction.
